(19) United States
(12) Patent Application Publication
(10) Pub. No.: US 2012/0060328 A1
(43) Pub. Date: Mar. 15, 2012

(54) BABY'S DUMMY CLIP

(75) Inventors: Peter Rohrig, Wein (AT); Ernst Beranek, Wein (AT)

(73) Assignee: MAM BABYARTIKEL GESELLSCHAFT M.B.H., Wein (AT)

(21) Appl. No.: 13/320,091

(22) PCT Filed: May 11, 2010
(86) PCT No.: PCT/AT2010/000161

§ 371 Date: Nov. 11, 2011

(30) Foreign Application Priority Data
May 11, 2009 (AT) A 710/2009

(51) Int. Cl. F16B 2/20

(52) U.S. Cl. 24/3.12

(57) ABSTRACT

There is disclosed a pacifier strap clip comprising two clamping parts which can be pivoted in relation to each other and have co-operating clamping regions, wherein, in a closed clamping position of the pacifier strap clip, opposing, inner-side surfaces of the clamping regions substantially rest against each other and, in its open position, the clamping regions are spaced apart from each other, wherein a closure part by means of which the clamping regions can be transferred into their clamping positions is rotatably mounted on one of the clamping parts and the closure part has at least one engaging device, so that, when the closure part is turned in the direction of the open position, the two clamping regions are moved away from each other.

The invention relates to a pacifier strap clip, or pacifier strap clip, comprising two clamping parts which can be pivoted in relation to each other and have co-operating clamping regions, wherein, in a closed clamping position of the pacifier strap clip, opposing, inner-side surfaces of the clamping regions substantially rest against each other, and, in its open position, the clamping regions are spaced apart from each other, wherein a closure part by means of which the clamping regions can be transferred into their clamping position is rotatably mounted on one of the clamping parts.

Clamps or clips for fastening pacifier or pacifier straps or the like at pieces of clothing of a baby or an infant or at other objects, such as an element of a baby buggy or perambulator, in principle are already known.

From US 2003/0115726 A1 there is known a clip of the initially mentioned type comprising two clamping parts which can be pivoted in relation to each other, wherein, in a closed clamping position, opposing, inner-side surfaces of clamping regions rest against each other, and, in an open position, the clamping regions are spaced apart from each other. For transferring the clamping regions into their clamping position, one clamping part has a set screw or bolt which extends through an aperture in the other clamping part and onto which a screw element can be screwed for closing the clip. In order to achieve an automatic transfer of the clamping regions into an open position when the screw element is turned in the direction of an open position, the material of which the clip consists must disadvantageously have a high inherent elasticity; otherwise the clamping regions remain in their closed position even if the screw element is turned in the direction of an open position.

In WO 2004/023919 A1 there is disclosed a clip for a pacifier or pacifier strap comprising a U-shaped profile part or U-section part made of a relatively hard synthetic material, such as polycarbonate. In this device, the surface of the clamping parts consists at least partially of a softer material, whereby an improved hold on smooth or thin fabrics or materials is ensured. For the transfer between the open position and the closed position, a bracket embracing the two clamping parts and being shiftably mounted on them is provided; thus, by shifting the bracket towards the freely cantilevering ends of the clamping parts, the clip can be closed. In principle, such a closing device comprising a bracket functions satisfactorily; for the automatic opening of the clip, however, it is necessary that the material of which the U-shaped profile part consists has a high inherent elasticity. Consequently, and disadvantageously, there are set close limits to the choice of the materials.

From DE 35 10 906 A1, a clip for suspenders is known in which a leaf spring substantially designed as a U-section carries two clamping jaws. In this case, however, the leaf spring has a bias so that the suspender clip is provided in a non-loaded position in its closed position and must be transferred into an open position by means of a cam.

A further pacifier or pacifier strap clip is known from U.S. Pat. No. 5,948,003 A. Here, two separate clamping parts are provided which are held in their closed position by means of a leg spring; this is a mechanism which is known for instance from clothes pegs. At the same time, said clip can be used as a cover or protection element for the pacifier nipple.

Also from DE 26 18 880 C2 there is known a clip, comprising two parts which are pivotable in relation to each other, which manages without a spring, a lever or a pin. The opening or closing of the clip is achieved by shifting a slide that is provided with a taper. This is an opening mechanism for the clip that has a complex construction and is not handy.

In contrast, the object of the present invention is to provide a pacifier strap clip in which a transfer between an open position and a closed position is possible in a simple manner, wherein a transfer into the open position shall be achievable by means of the closure part independent of the inherent elasticity of the material intended for the clip.

This is achieved in the pacifier strap clip of the initially mentioned kind in that the closure part has at least one engaging device so that, when the closure part is turned in the direction of the open position, the two clamping regions are moved away from each other. Thus, by means of the engaging device an automatic transfer of the clamping regions into an open position is reliably ensured when the closure part is turned correspondingly, and that independent of the material chosen for the clip, i.e. also in case of materials with a relatively low modulus of elasticity. Accordingly, a reliably opening clip that is easy to handle is created in which the material does not necessarily need to have a certain inherent elasticity.

A design of the clip having a simple construction and a low number of components is achieved when a substantially U-shaped profile part is provided the apex of which is formed as a pivoting region and the legs of which are formed as clamping parts.

A suitable device of a simple construction for engaging or driving along a clamping part during opening of the closure part is given when the engaging device comprises a connecting element which is connected with the clamping part which can be pivoted in relation to the clamping part receiving the closure part, said connecting element being connected with the rotatably mounted closure part via corresponding connecting surfaces. When the clip is opened, the closure part takes along the corresponding clamping part via the connecting element so that the clamping regions will reliably be moved away from each other. As a connecting element there can be provided in particular a circumferential flange with a catch-shaped connecting surface, which engages in a corresponding circumferential catch surface of the closure element. In an alternative design, at least one hook-shaped element engaging in an inner side of a clamping part is provided as an engaging element

In the past and up to now, very often polycarbonate has been proposed as the material for the clamping parts, as this material has a low creep tendency, and, consequently, a reliable return of the U-profile into a relaxed open position, for instance when a bracket is shifted, is ensured. A measure for the creep resistance of a material is given by the coefficient C_{c} which can take on values between 0 and 1. In this connection, the coefficient C_{c} is calculated from the ratio of the creep moduli E_{c3}and E_{c1} for the loading times t₃=1000 h and t₁=1 h, i.e. C_{c}=E_{c3}/E_{c1}. The value 1 describes a material without any creep; polycarbonate, for instance, has a creep resistance C_{c} of 0.86. A detailed discussion of the creep resistance C_{c} of synthetic materials can be found in the document by J. Kurz, “Kriechbeständigkeit—ein Kennwert für das Kriechverhalten”, (“Creep resistance: a characteristic value for creep behaviour”) in the magazine Kunststoffe 1/2004, Carl Hanser Verlag (publishing company), Munich, Germany. Due to the fact that in the inventive pacifier strap clip a low creep tendency is not necessarily required for the opening of the clip from its closed position, the U-shaped profile part can consist of a material with a creep resistance C_{c} of less than 0.86.

In order to ensure the health compatibility of the pacifier strap clip also for babies and infants, it is advantageous that the U-shaped profile part consists of a thermoplast, in particular polyester.

An advantageous design of the clip provides that a threaded connection is provided between the rotatably mounted closure part and the clamping part. When the closure part is rotated in both directions, by said threaded connection a change of the relative distance between the clamping regions is reliably ensured.

It is of particular advantage that the clamping part receiving the closure part has a cylindrical receiving element with a preferably segment-shaped female thread into which a cylindrical threaded portion of the closure part with a preferably segment-shaped male thread engages. Thus, a rotating of the closure part causes the male thread which is arranged at a cylindrical threaded portion of the closure part to engage in the female thread of the clamping part receiving the closure part, whereby the distance between the two clamping parts is changed. When the thread which is used has a high thread pitch, so that the clip will be transferred from the open position into the closed position by substantially only one single turn, the opening or closing of the clip is possible in a particularly simple and user-friendly manner.

In order to prevent an unintentional detachment or disengaging of the closure part from the cylindrical receiving element, it is favourable when the clamping part which is pivotable in relation to the clamping part receiving the closure part is connected to at least one, in particular ramp-shaped projecting part which has a stop face abutting at a corresponding stop face of the closure part in the open position of the clamping parts. Preferably, two opposing, ramp-shaped projecting parts are provided. Each ramp-shaped projecting part comprises a surface inclined with respect to the main extension plane of the connecting element and a stop face being arranged substantially perpendicular to the main extension plane of the connecting element which abuts at the corresponding stop face of the closure part after the turning of the closure part by a certain opening angle, so that a further turning of the closure part is prevented. The stop face of the closure element is preferably formed at a ramp-shaped projecting part of the closure element which is arranged at the inner side of the closure element. When the closure element is turned into the closed position, the inclined surface of the ramp-shaped projecting part of the connecting element can strike against the corresponding inclined surface of the ramp-shaped projecting part of the closure element. In order to prevent the unintentional detachment or disengagement of the closure part from the cylindrical receiving element, alternatively it can be provided that the male thread at the end thereof has a pin which is raised with respect to a root of thread.

In order to prevent an unintentional opening of the clip in the closed position, it is favourable that the closure part has an operating element the bottom side of which, in the clamping position, rests against the clamping part lying opposite the clamping part comprising the cylindrical receiving element, wherein at the bottom side of the operating part and on the surface of the clamping part facing the operating part there are provided meshing teeth.

In order to ensure a particular good hold of the clip at a piece of clothing or the like, a high stiffness of the clip is advantageous. A design which is favourable to this effect provides at one of the clamping parts at least in the clamping region a curvature being convex in relation to the inner-side surface of the clamping parts, whereby an improved hold of the clip is achieved.

In the following, the present invention will be explained in more detail by means of the preferred exemplary embodiments illustrated in the drawings, to which, however, the invention shall not be restricted. In detail,

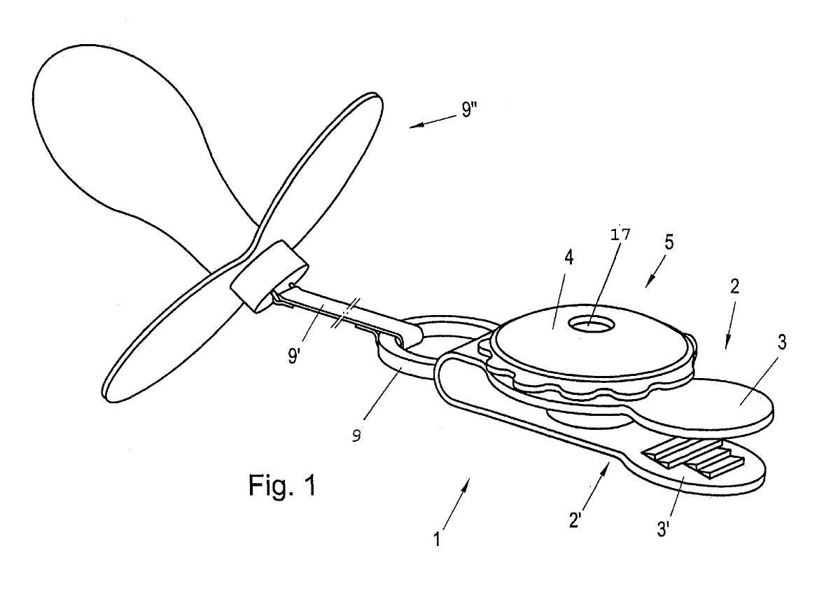

FIG. 1 shows a perspective view of a pacifier strap clip with a U-shaped profile part and a rotatable closure part;

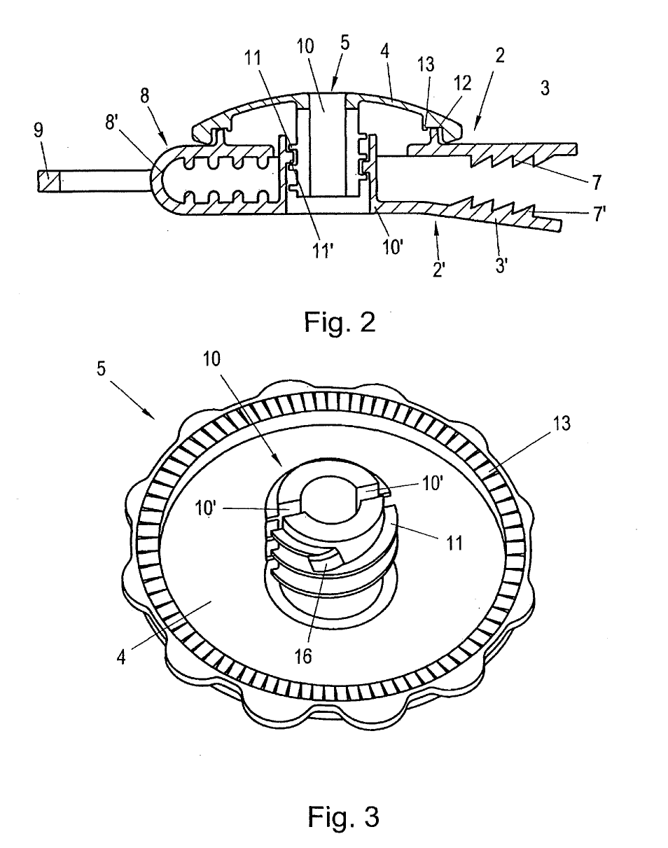

FIG. 2 shows a section according to line II-II of FIG. 1;

FIG. 3 shows a perspective view of the bottom side of the closure part;

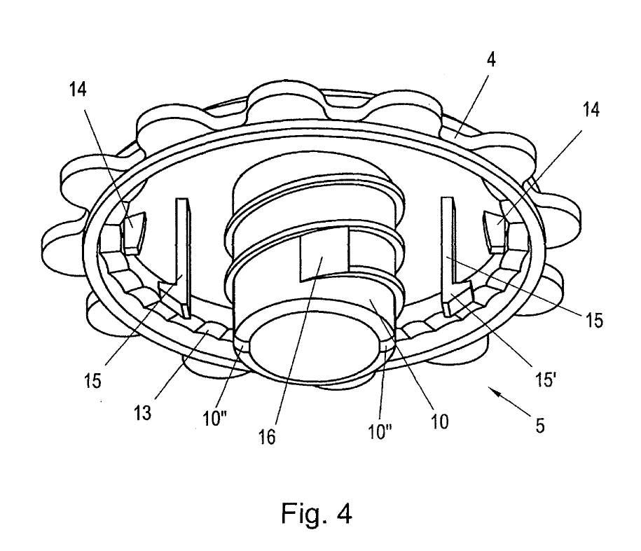

FIG. 4 shows a perspective view of the bottom side of a closure part comprising two engaging or driving hooks;

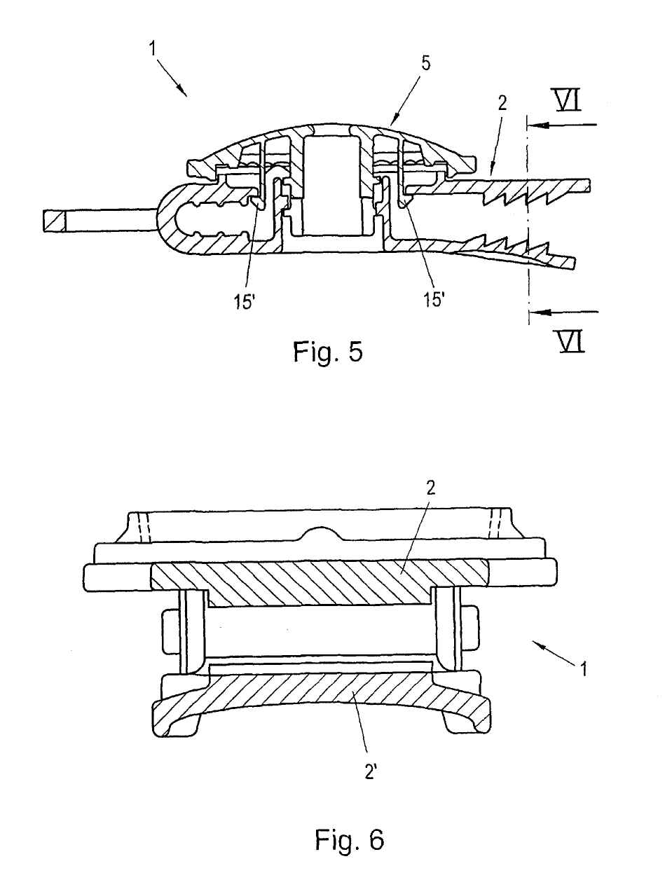

FIG. 5 shows a section of the clip as shown in FIG. 2, wherein, however, a closure part comprising engaging or driving hooks is provided;

FIG. 6 shows a section of the clip (without closure part) according to line VI-VI of FIG. 5 with a convexly curved clamping part;

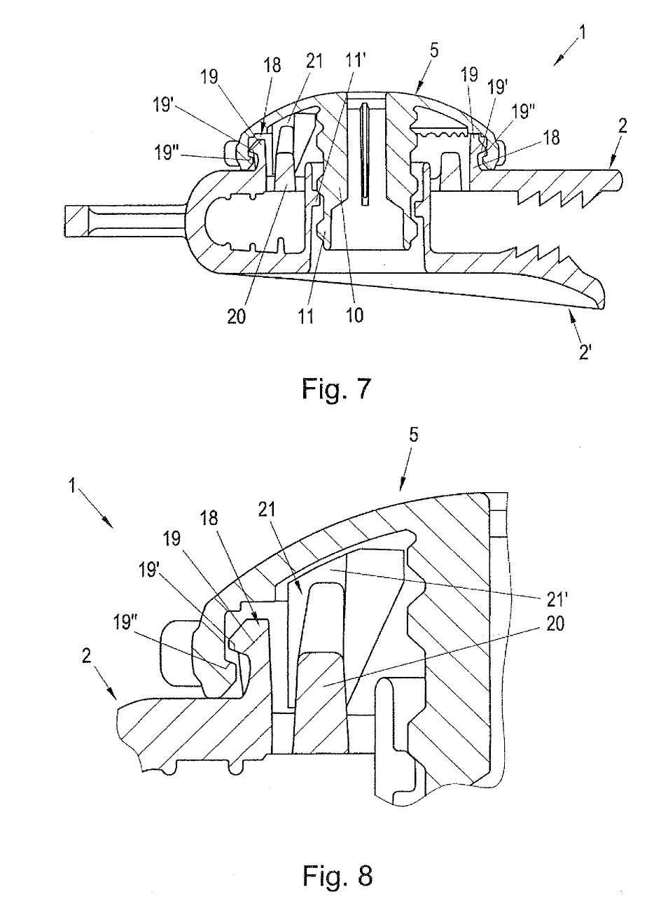

FIG. 7 shows a sectional view of a further design of the clip; and

FIG. 8 shows a detailed view of an engaging or driving device.

In FIGS. 1 and 2 there is shown a pacifier strap clamp or clip 1, respectively, comprising two clamping parts 2, 2′ which each comprise a clamping region 3, 3′. FIG. 1 shows the clamping parts 2, 2′ in their open position in which the two clamping regions 3, 3′ are arranged spaced from each other. By means of turning at or rotating an operating element 4 of a closure part 5, the clamping parts 2, 2′ can be transferred from their open position into their closed position, whereby the two clamping regions 3, 3′ are approximated to each other and, thus, the clip 1 can be fastened to different objects, for instance pieces of clothing, a side wall or a cover of a baby buggy or the like. In this connection, the outer contour of the circular operating element 4 is formed such that it has the shape of waves or is rippled or grooved, so that the fingers can grasp into the recessed regions at the operating element 4, and, consequently, a good hold can be achieved when turning the operating element 4. In addition, it is favourable when the outer diameter of the circular operating element 4 has at least 39 mm so that a one-hand operation is possible in a simple manner. The operating element 4 as well as the clip 1 have a substantially smooth surface, so that they can be printed for decoration purposes in a simple manner.

As is illustrated in FIG. 1, the closure part 5 is provided with a ventilation aperture 17. For reasons concerning standard and safety regulations, the diameter of the ventilation aperture 17 is at least 4 mm, wherein the aperture diameter is preferably chosen to be smaller than 5 mm or larger than 12 mm in order to avoid that a finger of a child gets stuck in the ventilation aperture 17.

In the clamping regions 3, 3′, the opposing surfaces each have a toothed profile 7, 7′ whereby an improved hold of the clip 1 is obtained when for instance a thin piece of clothing is being clamped.

The two clamping parts 2, 2′ are formed as legs of a U-profile or U-section 8 (see FIG. 2), wherein an apex region 8′ of the U-profile 8 is formed as a pivoting region for the two clamping parts 2, 2′. In addition, in the apex region 8′ a fastening ring 9 having the shape of a portion of a circular ring is provided at which a pacifier strap or pacifier strap 9′ with a pacifier or pacifier 9″ can be attached. The end of the pacifier strap 9′ connected with the fastening ring 9 which can be formed as a loop as is illustrated in FIG. 1, is advantageously freely shiftable with respect to the fastening ring 9, so that the movability of the pacifier strap 9′ will not be restricted by the fastening to the clip 1. Due to safety reasons, also the fastening ring 9 has an inner diameter of at least 12 mm in order to avoid the risk of injury through pinching of fingers.

As can be seen in FIG. 2, a cylindrical threaded portion 10 of the closure part 5 with a male thread 11 is received in a female thread 11′ which is formed in a cylindrical receiving element 10′ of the lower clamping part 2′. Thus, in dependence on the direction of turning of the closure part 5, due to the resting of the operating element 4 at the upper clamping part 2 the two legs of the U-profile 8, i.e. the clamping parts 2, 2′, will either be approximated to each other or, however, a transfer into the opened initial position is rendered possible. Both threads 11, 11′ each have a high thread pitch so that less than one single or a maximum of one single turn is required in order to transfer the clip 1 from the open position into the closed position.

As can be seen particularly in FIG. 3, the cylindrical threaded portion 10 of the closure part 5 has two diametrically arranged, slot-shaped openings 10″ extending in the longitudinal direction of the cylinder. Thereby the threaded portion 10 can be compressed and inserted into the receiving element 10′. At the end thereof, the threaded portion 10 has a pin 16 raised with respect to a thread root 16′, by means of which there is prevented an unintentional detaching or disengaging of the closure part 5 from the receiving element 10′ in that, in a non-compressed position of the threaded portion 10, said pin strikes against a flank of the female thread 11′, provided that the closure part 5 is arranged in its open position. Herein, the male thread 11 is formed as a double-threaded thread in order to increase the transmitted forces at the comparatively large thread pitch.

As can be seen in FIG. 2 and FIG. 3, the closure part 5 is held in its closed position (i.e. is blocked against an unintentional turning back) in that at the bottom side of the operating part 4 and on the surface of the clamping part 2 facing the operating part 4 meshing teeth 12, 13 are provided.

As can be seen in FIG. 4, at the bottom side of the operating part 4, adjacent to a toothed ring formed by the teeth 13, pins 14 can be provided which, in the closed position, strike against a corresponding counter-element of the U-profile 8 (not shown) and, thus, prevent a further turning of the closure part 5; hence, an excessive tightening of the closure part 5 and, consequently, the breaking of the thread-receiving element 10′ can be avoided.

In FIGS. 4 and 5 there can be further seen two engaging or driving elements 15 which, with their hook-shaped projecting parts 15′, engage behind the clamping part 2. Thus, during the opening process, the hook-shaped projecting parts 15′ of the engaging element 15 abut at an inner side of the clamping part 2, so that, when the closure part 5 is shifted by being turned or rotated, the clamping parts 2, 2′ will be automatically drawn apart. Thereby it is advantageously ensured that, also when for the U-profile 8 a synthetic material is used which has a comparatively low elasticity, i.e. for instance polyester, or other synthetic materials are used which have a very good health compatibility, even after remaining quite a long time in the closed position, an opening of the clamping parts 2, 2′ will be ensured by a turning of the closure part 5, without the user having to apply a special pulling force to the clamping parts 2, 2′ in order to move them apart.

In FIG. 6 it can further be seen that the lower clamping part 2′ has a curvature being convex relative to the opposing, inner sides of the clamping parts 2, 2′, whereby a higher stiffness and, consequently, an improved hold of the clip 1 at different objects can be achieved.

FIGS. 7 and 8 show a further design of the clip 1 in which, as an engaging or driving device 15, a connecting element 18 connected with the clamping part 2 pivotable in relation to the clamping part 2′ receiving the closure part is provided. The connecting element 18 is formed by a circumferential flange 19 integrally connected with the clamping part 2, which has a catch-shaped connecting surface 19′ for a corresponding connecting surface 19″ of the closure part 5. In this connection, the engaging connecting surfaces 19′, 19″ ensure the required rotatable mounting of the closure part 5 with respect to the connecting element 18. On being turned, the closure part 5 takes along the clamping part 2 due to the positive connection with the connecting part 18, so that the clamping regions 3, 3′ are moved apart from each other.

As can be seen in FIG. 7 and FIG. 8, the clamping part 2 is connected with two ramp-shaped projecting parts 20 arranged at opposing locations. The projecting parts 20 each have a stop face 20′ which, in the shown open position of the clamping parts 2, 2′, abut at a corresponding stop face 21′ of an also ramp-shaped projecting part 21 which is connected with the inner side of the closure part 5. In addition, the ramp-shaped projecting parts 20, 21 comprise inclined surfaces which strike against each other when the closed position of the clip 1 is reached.

1. A pacifier strap clip comprising a substantially U-shaped profile part the apex of which is formed as a pivoting region and the legs of which are formed as clamping parts which can be pivoted in relation to each other and have co-operating clamping regions, wherein, in a closed clamping position of the pacifier strap clip, opposing, inner-side surfaces of the clamping regions substantially rest against each other and, in its open position, the clamping regions are spaced apart from each other, wherein a closure part by means of which the clamping regions can be transferred into their clamping position, is rotatably mounted on one of the clamping parts, wherein the closing part has at least one engaging device so that, when the closure part is turned in the direction of the open position, the two clamping regions are moved away from each other.

2. (canceled)

3. The pacifier strap clip according to claim 1, wherein the engaging device comprises a connecting element connected with the clamping part which can be pivoted in relation to the clamping part receiving the closure part, said connecting element being connected with the rotatably mounted closure part via corresponding connecting surfaces.

4. The pacifier strap clip according to claim 1, wherein the U-shaped profile part consists of a material with a creep resistance C_{c} of less than 0.86.

5. The pacifier strap clip according to claim 1, wherein the U-shaped profile part (8) consists of a thermoplast, in particular polyester.

6. The pacifier strap clip according to claim 1, wherein between the rotatably mounted closure part and the clamping part there is provided a threaded connection.

7. The pacifier strap clip according to claim 1, wherein the clamping part receiving the closure part comprises a cylindrical receiving element with a preferably segment-shaped female thread into which a cylindrical threaded portion of the closure part with a preferably segment-shaped male thread engages.

8. The pacifier strap clip according to claim 7, wherein the clamping part which can be pivoted in relation to the clamping part receiving the closure part is connected with at least one, in particular ramp-shaped projecting part which has a stop face which, in the open position of the clamping parts, abuts at a corresponding stop face of the closure part.

9. The pacifier strap clip according to claim 1, wherein the closure part comprises an operating element the bottom side of which, in the clamping position, abuts at the clamping part lying opposite the clamping part comprising the cylindrical receiving element, wherein at the bottom side of the operating element and on the surface of the clamping part facing the operating element meshing teeth, are provided.

10. The pacifier strap clip according to claim 1, wherein one of the clamping parts at least in the clamping region has a curvature being convex with respect to the inner-side surface of the clamping parts.
